(19) United States
(12) Patent Application Publication
(10) Pub. No.: US 2026/0086510 A1
(43) Pub. Date: Mar. 26, 2026

(54) METHOD AND APPARATUS FOR CONTROLLING PRODUCTION LINES BASED ON PREDICTION OF PRODUCT LIFETIME TOTAL SALES VOLUME THROUGH HYBRID MACHINE LEARNING MODEL

(71) Applicant: Impactive Al, Pohang-si (KR)

(72) Inventor: Doo Hee CHUNG, Pohang-si (KR)

(21) Appl. No.: 19/405,411

(22) Filed: Dec. 2, 2025

Related U.S. Application Data
(63) Continuation-in-part of application No. 18/673,404, filed on May 24, 2024.

(30) Foreign Application Priority Data
May 25, 2023 (KR) 10-2023-0067580

(51) Int. Cl. G05B 13/02; G06Q 30/0201

(52) U.S. Cl. CPC G05B 13/0265; G06Q 30/0201

(57) ABSTRACT

A method and an apparatus for controlling production lines based on prediction of a product lifetime total sales volume through a hybrid machine learning model. The method may include: constructing a first model on the basis of modeling data in a machine learning model; constructing a second model on the basis of product lifespan information predicted by the first model and the modeling data in the machine learning model; predicting a lifetime lifespan of test data and creating lifetime lifespan prediction data by inputting the test data into the first model; predicting a lifetime total sales volume by inputting the lifetime lifespan prediction data and the test data into the second model; and transmitting a control signal to the production lines, such that a production volume of a new product is directly controlled, in real time, based on the predicted lifetime total sales volume.

### CROSS-REFERENCE TO RELATED APPLICATIONS

This is a continuation in part application claiming priority from U.S. Non-Provisional patent application Ser. No. 18/673,404, filed on May 24, 2024, the entire contents of which are hereby incorporated by reference.

### BACKGROUND

### Technical Field

The present disclosure relates to a method and apparatus for predicting a product lifetime total sales volume through a hybrid model based on machine learning. The present disclosure relates to a method and apparatus for predicting a product lifetime total sales volume through a hybrid model based on machine learning, the method and apparatus being able to construct a hybrid model, which predicts lifetime total demand of products that will be made in the future by respective products through a machine learning model, and to predict accurate lifespans and lifetime total sales volumes of the products using the hybrid model.

### Background Art

In general, predicting and managing the lifecycle of products is essential for improving the competitiveness of companies. Product lifetime prediction optimizes a company's management performance by reducing uncertainty and the risk burden when implementing strategies such as sales, production, finance, and purchasing in management activities. Further, it is possible to check the states of products in the market and efficiently map out strategies for advantageous competition such as product positioning and market searching by managing the lifespan of products. In particular, it is necessary to predict the lifetime total sales volume of a product in order to maximize the sales performance of the product in a long-term perspective, which can also be achieved through easy prediction of lifespan.

Recently, various attempts have been made to increase the performance of demand prediction on the basis of machine learning. First, hybrid approaches of attempting prediction by combining various models in consideration of the complex contexts in prediction without performing prediction through a single machine learning model show excellent performance in many cases. There has been proposed a methodology of predicting each weekly quantity demanded by constructing a model for predicting a weekly demand pattern of a product using K-means and Random forest, constructing a model for predicting the total sales volume for a specific period by combining Quantile Regression Forest (QRF), and combining the two models. This methodology constructs an optimal model by decomposing the situation to predict into detailed factors called a demand pattern and a total sales volume and applying an appropriate machine learning algorithm to the factors.

However, since there is a temporal prerequisite called an entire lifespan period to predict a lifetime total sales volume of a product, it is required first to predict the lifespan of the product. This is because even though sales volumes at the early stage increase to similar levels in a group of same products, the total sales volumes may be different, depending on the time of the end of life. It is possible to make a more excellent model for predicting lifetime total demand of products by predicting the lifespan of a product, applying the lifespan to main features, and then predicting total demand using them as a dataset.

There is Korean Patent No. 10-2447055 (Method and apparatus for predicting demand of product) as a prior document, but this only provides a method and apparatus for predicting demand of products, the method and apparatus predicting demand of a product on a specific date by applying a store-specific demand prediction function to each store or predicting store-specific demand of a product on a specific date on the basis of customers, customer-specific purchase prediction function, a new purchase constant, and a stock prediction quantity.

### SUMMARY

The present disclosure has been made in an effort to solve the problems in the related art, and an objective of the present disclosure is to provide a method and apparatus for predicting a product lifetime total sales volume, the method and apparatus being able to construct a hybrid model, which predicts lifetime total demand of products that will be made in the future by respective products through a machine learning model, and to predict accurate lifespans and lifetime total sales volumes of the products using the hybrid model.

A method of predicting a product lifetime total sales volume through a hybrid model based on machine learning according to the present disclosure includes: constructing a first model configured to predict a product lifespan on the basis of modeling data in a machine learning model by means of a first model construction unit; constructing a second model configured to predict a product total sales volume on the basis of product lifespan information predicted by the first model and the modeling data in the machine learning model by means of a second model construction unit; predicting a lifetime lifespan of test data and creating lifetime lifespan prediction data by inputting the test data into the first model by means of a lifespan prediction unit; and predicting a lifetime total sales volume by inputting the lifetime lifespan prediction data and the test data into the second model by means of a total sales volume prediction unit.

An apparatus for predicting a product lifetime total sales volume through a hybrid model based on machine learning according to the present disclosure includes: a first model construction unit configured to construct a first model configured to predict a product lifespan on the basis of modeling data in a machine learning model; a second model construction unit configured to construct a second model configured to predict a product total sales volume on the basis of product lifespan information predicted by the first model and the modeling data in the machine learning model; a lifespan prediction unit configured to predict a lifetime lifespan of test data and create lifetime lifespan prediction data by inputting the test data into the first model; and a total sales volume prediction unit configured to predict a lifetime total sales volume by inputting the lifetime lifespan prediction data and the test data into the second model.

Further, a method for controlling production lines based on prediction of a product lifetime total sales volume through a hybrid machine learning model according to the present disclosure includes: (a) constructing a first model configured to predict a product lifespan on the basis of modeling data in a machine learning model; (b) constructing a second model configured to predict a product total sales volume on the basis of product lifespan information predicted by the first model and the modeling data in the machine learning model; (c) predicting a lifetime lifespan of test data and creating lifetime lifespan prediction data by inputting the test data into the first model; (d) predicting a lifetime total sales volume by inputting the lifetime lifespan prediction data and the test data into the second model; (e) transmitting a control signal to the production lines, such that a production volume of a new product is directly controlled, in real time, based on the predicted lifetime total sales volume; and (f) repeating steps (a) through (e) as the modeling data being updated in real time.

Further, a method for controlling an inventory management scheduler based on prediction of a product lifetime total sales volume through a hybrid machine learning model according to the present disclosure includes: (a) constructing a first model configured to predict a product lifespan on the basis of modeling data in a machine learning model; (b) constructing a second model configured to predict a product total sales volume on the basis of product lifespan information predicted by the first model and the modeling data in the machine learning model; (c) predicting a lifetime lifespan of test data and creating lifetime lifespan prediction data by inputting the test data into the first model; (d) predicting a lifetime total sales volume by inputting the lifetime lifespan prediction data and the test data into the second model; (e) transmitting a control signal to the an inventory management scheduler, in real time, based on the predicted lifetime total sales volume; and (f) repeating steps (a) through (e) as the modeling data being updated in real time.

### Advantageous Effects

The present disclosure can construct a hybrid model by combining machine learning models on the basis of a product total lifespan prediction value.

The present disclosure can provide high reliability in comparison to existing prediction models based on a relatively short-term pattern to predict demand on the basis of product total lifespan.

The present disclosure can provide a more precise demand prediction result of products by using a framework combining the advantages of two machine learning models having high prediction performance.

### BRIEF DESCRIPTION OF THE DRAWINGS

FIG. 1 is a flowchart illustrating a method of predicting a product lifetime total sales volume through a hybrid model based on machine learning according to an embodiment of the present disclosure.

FIG. 2 is a configuration diagram of an apparatus for predicting a product lifetime total sales volume through a hybrid model based on machine learning according to an embodiment of the present disclosure.

FIG. 3 and FIG. 4 are tables showing variable composition of training data according to an embodiment of the present disclosure.

FIG. 5 is a table showing hyperparameters of respective models according to an embodiment of the present disclosure.

FIG. 6 is a table showing model accuracy in product lifespan prediction according to an embodiment of the present disclosure.

FIG. 7 is a table comparing accuracy of lifetime total sales volume prediction models on the basis of RMSE, NRMSE, MAE, mMAPE, etc. according to an embodiment of the present disclosure.

FIG. 8 is a flowchart illustrating a for controlling production lines based on prediction of machine learning models according to one embodiment of the present disclosure.

FIG. 9 is a block diagram of an apparatus for controlling production lines based on prediction of machine learning models according to one embodiment of the present disclosure.

FIG. 10 is a block diagram of an apparatus for controlling an inventory management scheduler based on prediction of machine learning models according to one embodiment of the present disclosure.

### DETAILED DESCRIPTION OF EXEMPLARY EMBODIMENTS

Specific structural and functional description of embodiments according to the concept of the present disclosure disclosed herein is exemplified only to describe the embodiments according to the concept of the present disclosure, and the embodiments according to the concept of the present disclosure may be implemented in various ways and are not limited to the embodiments described herein.

Embodiments described herein may be changed in various ways and various shapes, so specific embodiments are shown in the drawings and will be described in detail in this specification. However, it should be understood that the exemplary embodiments according to the concept of the present disclosure are not limited to the specific examples, but all of modifications, equivalents, and substitutions are included in the scope and spirit of the present disclosure.

The terminology used herein is for the purpose of describing particular embodiments only and is not intended to limit the present disclosure. Singular forms are intended to include plural forms unless the context clearly indicates otherwise. It will be further understood that the terms “comprises” or “have” used in this specification, specify the presence of stated features, numbers, steps, operations, components, parts, or a combination thereof, but do not preclude the presence or addition of one or more other features, numerals, steps, operations, components, parts, or a combination thereof.

Hereinafter, embodiments of the present disclosure will be described in detail with reference to the accompanying drawings.

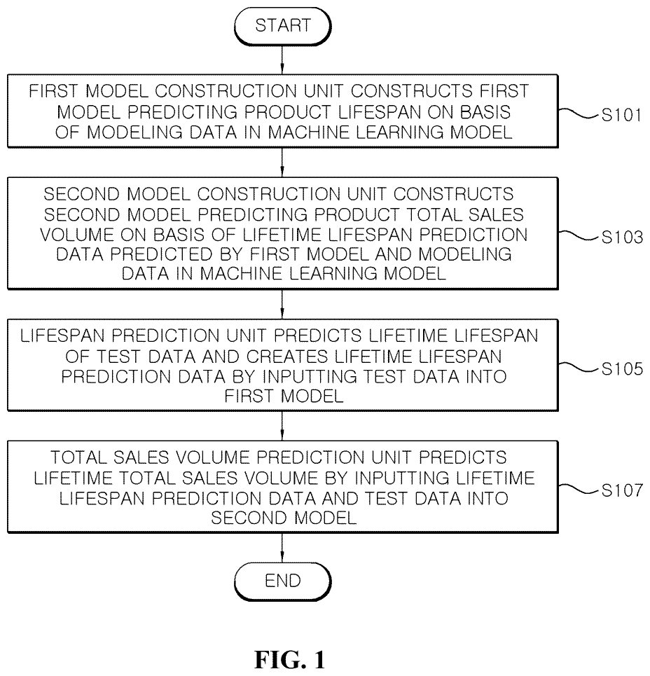

FIG. 1 is a flowchart illustrating a method of constructing a hybrid model based on machine learning for predicting product lifetime total sales performance according to an embodiment of the present disclosure.

Referring to FIG. 1, a first model construction unit 110 constructs a first model that predicts a product lifespan on the basis of modeling data in a machine learning model (S101). In this case, the modeling data may be at least one of actual lifespan data, product attribute data, and product sale information. The product sale information data is at least one of time-series data, selling date and time, a sales volume, and a selling price about the sales record of each product. The product attribute data may be at least one of a product item, a product price, and a product design. The machine learning model may be Light Gradient-Boosting Machine (LGBM) model and the LGBM model can calculate an estimation value of accurate information acquisition even through a small data size, so the LGBM model makes it possible to achieve high accuracy in lifespan prediction.

A second model construction unit 120 constructs a second model that predicts a product total sales volume on the basis of the lifetime lifespan prediction data predicted from the first model and modeling data in the machine learning model (S103). The second model is a product total sales volume model and can predict a total sales volume for a lifetime total lifespan of a product. The machine learning model may be a Quantile Boost (QBoost) model and the QBoost model is a boosting model based on Quantile Regression (QR). A quantile regression-based model is advantageous in prediction of data having an outlier or data of which an error term follows distribution with a thick tail. Since a product lifetime total sales volume has an entire lifetime period as the range, the error range is wide, so this model is suitable.

A lifespan prediction unit 150 predicts the lifetime lifespan of test data and creates lifetime lifespan prediction data by inputting the test data into the first model (S105). The lifespan prediction unit 150 can predict the lifespan of a product using the first model constructed by the first model construction unit 110 and can predict the lifetime lifespan of test data and create lifetime lifespan prediction data by inputting the test data into the first model. In this case, the test data may be data including only product attribute data and product sale information without lifespan data, but is not necessarily limited thereto.

A total sales volume prediction unit 160 predicts a lifetime total sales volume by inputting the lifetime lifespan prediction data and the test data into the second model (S107). The total sales volume prediction unit 160 can predict a product lifetime total sales volume using the second model constructed by the second model construction unit 120. The total sales volume prediction unit 160 can predict a product lifetime total sales volume by inputting the lifetime lifespan prediction data and the test data into the second model.

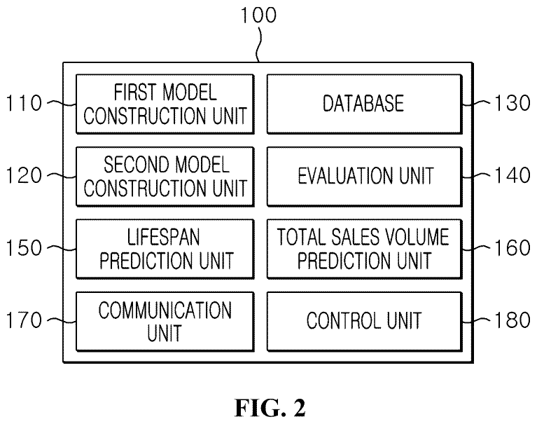

FIG. 2 is a configuration diagram of a hybrid model construction device based on machine learning for predicting product lifetime total sales performance according to an embodiment of the present disclosure.

Referring to FIG. 2, an apparatus 100 for predicting a product lifetime total sales volume through a hybrid model based on machine learning is composed of a first model construction unit 110, a second model construction unit 120, a database 130, an evaluation unit 140, a lifespan prediction unit 150, a total sales volume prediction unit 160, a communication unit 170, and a control unit 180.

The first model construction unit 110 can construct a first model that predicts a product lifespan on the basis of modeling data in a machine learning model. In this case, the modeling data may be at least one of actual lifespan data, product attribute data, and product sale data. The product sale information data is at least one of time-series data, selling date and time, a sales volume, and a selling price about the sales record of each product. The product attribute data may be at least one of a product item, a product price, and a product design. The first model construction unit 110 can construct a first model and create lifetime lifespan prediction data through the first model.

The machine learning model may be a Light Gradient Boosting Machine (LGBM) model and the LGBM model, which is a lightweight ensemble learning algorithm based on a Gradient Boosting Machine (GBM) of the related art, is a model of which the applicability was expanded and the performance was improved from existing models. The LGBM model can calculate an estimation value of accurate information acquisition even through a small data size, so the LGBM model makes it possible to achieve high accuracy in lifespan prediction. A GBM usually shows high prediction performance, but may cause problems with a speed and a memory when the data size is large. The LGBM is an algorithm that uses a small memory and shows high prediction performance to solve this problem.

The LGBM is a model obtained by adding two types of methods to an existing GBM to improve efficiency for high-dimensional variables and large-scale data. The first one is Gradient-based One-side Sampling (GOSS), which increases learning efficiency by minimizing unnecessary calculation by optionally removing instances having small inclination while keeping instances having large inclination. GOSS makes it possible to calculate an estimation value of accurate information acquisition even through a small data size. The second method is exclusive feature bundling, which increases a learning speed by limiting the number of variables by binding mutually exclusive variables into one. In terms of algorithm structure, the LGBM actively uses vertical growth (leaf-wise growth), which can be differentiated from other GBM-based algorithms that use horizontal growth.

An algorithm made in this way creates a decision tree-based base classifier and calculates a weight parameter of each classifier in repetition, whereby a training process is made. All of the base classifiers and their weights are combined in a final model formation process, and the formula is as the following [Formula 1].

$${υ}_{j \vert 0} ( d ) = \frac{1}{n 0} ( \frac{{( \sum \{ {x}_{i} ∈ 0 : {x}_{ij} \leq d \} {g}_{i} )}^{2}}{{n}_{l \vert 0}^{j} ( d )} + \frac{{( \sum \{ {x}_{i} ∈ 0 : {x}_{ij} > d \} {g}_{i} )}^{2}}{{n}_{r \vert 0}^{j} ( d )} ) \qquad [ Formula 1 ]$$

[Formula 1] denotes training data as 0 and can define a distributed gain at node d where the input variable j divides the tree. From [Formula 1], it is possible to determine dⱼ that is a node that maximizes a distributed gain vⱼ(d) for an input variable j and it is possible to determine a tree by making child nodes diverge left and right from the node. In this case, gᵢ means the negative inclination of a loss function for output of a model and Xⱼ means input data. Accordingly, the LGBM can accelerate a training process up to maximum 20 times while achieving accuracy that is the same as or higher than that of other GBDT algorithms.

The second model construction unit 120 can construct a second model that predicts a product total sales volume on the basis of the lifetime lifespan prediction data predicted from the first model and modeling data in a machine learning model. The second model is a product total sales volume model and can predict a total sales volume for a lifetime total lifespan of a product. The machine learning model may be a Quantile Boost (QBoost) model and the QBoost model is a boosting model based on Quantile Regression (QR).

Quantile Regression (QR) is a kind of regression analysis, and common regression analysis predicts an average value, but QR predicts a specific quantile value in consideration of distribution of data. A quantile regression-based model is advantageous in prediction of data having an outlier or data of which an error term follows distribution with a thick tail. Since a product lifetime total sales volume has the entire lifetime period as the range, the error range is wide, so this model is suitable. QR is useful when attempting prediction of a specific part of data distribution such as an outlier of a data. Further, QR is usefully used in the situation in which prediction according to a confidence interval is performed or distribution of dependent variables has heteroscedasticity. In general, since an average value is sensitive to an outlier of data, when data is not uniformly distributed, the existing common regression-based approaches may calculate a wrong prediction value. However, since QR performs prediction for each quantile, it can more firmly deal with an outlier in comparison to an average value. Further, common regression has strict assumption for normal distribution and does not fit to the reality in many cases, but QR does not require such assumption.

$${Q}_{τ} ( {y}_{i} ) = {β}_{0} ( τ ) + {β}_{1} ( τ ) {x}_{i 1} + … + {β}_{p} ( τ ) {x}_{ip} \qquad [ Formula 2 ]$$

[Formula 2] is a quantile regression model equation for a τ-th quantile, in which p is the number of regression variables and i is a data index. A conditional quantile value is predicted rather than an existing conditional average value through [Formula 2].

$$MAD = \frac{1}{n} {\sum }_{i = 1}^{n} {p}_{τ} ( {y}_{i} - ( {β}_{0} ( τ ) + {β}_{1} ( τ ) {x}_{i 1} + … + {β}_{p} ( τ ) {x}_{ip} ) ) \qquad [ Formula 3 ]$$

[Formula 3] is a formula for obtaining Median Absolute Deviation (MAD) and finds out an optimal quantile equation by minimizing an MAD value. In this case, p is the number of regression variables and i is a data index. i is an indicator function and returns 1 for true and 0 for false. ρᵣ, which is a quantile loss function, gives an asymmetric weight, and in this case, follows the quantile of an error and the sign of the entire and has the form of the following [Formula 4].

$${ρ}_{τ} ( r ) = rI ( r ⩾ 0 ) - ( 1 - τ ) r \qquad [ Formula 4 ]$$

A Quantile Boost (QBoost) model is obtained by applying the quantile regression method to a boosting model and is based on a gradient boosting algorithm of boosting. QBoost has the advantages of QR, that is, has the feature of being able to handle multidimensional problems for each quantile, and particularly, has a strong ability to solve problems in a high-dimensional space and is excellent in prediction of variables with many noises through synergy with a boosting model. A gradient boosting model is a model that learns data through a process of repeatedly forming individual decision trees, which predict the errors of the previous models, M times. The gradient boosting model has the sum of individual decision trees formed as a learning result as a final model.

A QBoost algorithm performs learning through a process of repeatedly forming individual trees in the same way as the gradient boosting model. The QBoost algorithm starts with defining an initial model f^{[0]} for forming individual trees and can set the initial model as at least one of f^{[0]}=0 and f^{[0]}=τ-th quantile of (Yᵢ . . . Yₙ). The QBoost algorithm learns a final model by repeating this process M times after defining the initial model.

When the current stage is m, a negative gradient that minimizes a loss function is obtained to a prediction value of a previous model. When a negative gradient is Uᵢ, a formula for obtaining Uᵢ is as the following [Formula 5].

$$\begin{matrix}{U}_{i} = - \frac{\partial I ( {Y}_{i} , f )}{\partial f} {\vert}_{f = {f}^{[ m - 1 ]} ( {x}_{i} )} , & i = 1 , … , n .\end{matrix} \qquad [ Formula 5 ]$$

In this formula, Yᵢ is the actual value of i-th data and f is a prediction value of a previous model. That is, Uᵢ is a value obtained by substituting Yᵢ and f^{[m-1]}(xᵢ) into a formula derived from differentiating a loss function l(Y, f) with respect to f.

The following [Formula 6] is a formula for a quantile loss function and the QBoost algorithm uses ρᵥ, which is a quantile loss function, as a loss function and is trained to minimize ρ_{τ}.

$$l ( Y , f ) = {ρ}_{τ} ( Y - f ) = ( Y - f ) I ( Y - f ⩾ 0 ) - ( 1 - τ ) ( Y - f ) \qquad [ Formula 6 ]$$

Accordingly, a formula finally derived from differentiating ρ_{τ}(Y−f) with respect to f to obtain a negative gradient f in QBoost is as the following [Formula 7].

$$\begin{matrix}{U}_{i} = I ( {Y}_{i} - {f}^{[ m - 1 ]} ( {x}_{i} ) \geq 0 ) - ( 1 - τ ) , & i = 1 , … , n\end{matrix} \qquad [ Formula 7 ]$$

The QBoost algorithm learns a new individual tree g^{[m]} having all of negative gradient vectors as objective variables and then changes the model prediction value at the m-th stage as in the following [Formula 8].

$${f}^{[ m ]} ( \cdot ) = {f}^{[ m - 1 ]} ( \cdot ) + {η}_{m} {g}^{[ m ]} ( \cdot ) . \qquad [ Formula 8 ]$$

In this case, leaning continues until the number of iterations reaches M while applying a weight by a learning rate ηₘ. In general, performance is similar when the learning rate ηₘ is smaller than 0.125, so a sufficiently small learning rate value of 0.1 or less is used.

The QBoost algorithm learns a model using a quantile function for residuals in the method described above and derives an optimal quantile prediction value while repeating the process of updating parameter values of a new model.

The database 130 can store modeling data, the first model constructed by the first model construction unit 110, and the lifetime lifespan prediction data created through the first model. Further, the database 130 can store the second model constructed by the second model construction unit 120. Further, the database 130 can store all of information that is created in the apparatus 100 for predicting a product lifetime total sales volume through a hybrid model based on machine learning.

The evaluation unit 140 can evaluate the performance of the second model on the basis of the product lifetime total sales volume predicted by the total sales volume prediction unit 160 and the key performance criteria for evaluating performance may be Roost Mean Square Error (RMSE), Normalized Root Mean Square Error (NRMSE), Mean Absolute Error (MAE), and Maximum Mean Absolute Percentage Error (mMAPE) but are not necessarily limited thereto.

Root Mean Square Error (RMSE) is obtained by calculating the square root of the difference of mean squares of a Mean Square Error (MSE) predicted value and an actual value. Taking a square root has the advantages in that distortion of a squared value is removed and it is less sensitive to an outlier. NRMSE is obtained by standardizing an RMSE value by dividing RMSE by the difference between a maximum value and a minimum value. MAE obtains an average by converting the differences between actual values and predicted values into absolute values and then summing up the absolute values. mMAPE expresses an MAE value in percentage. [symbol] ᵢ|ₘₐₓ of mMAPE is the maximum absolute value of an actual value. A proposed formula defines two formulae, depending on cases of the | [symbol] ᵢ|ₘₐₓ value. When | [symbol] ᵢ|ₘₐₓ is less than 1, the difference between an actual value and a predicted value is calculated as an evaluation value. | [symbol] ᵢ|ₘₐₓ When | [symbol] ᵢ|ₘₐₓ is greater than 1, an error value is calculated by dividing the difference between an actual value and a predicted value by the absolute value of the actual value. Similar to MAPE, the magnitude of an error is influenced by the difference between an actual value and a predicted value. Formulae according to performance criteria are the following [Formula 9] to [Formula 12].

$$RMSE = \sqrt{\frac{1}{n} {\sum }_{i = 1}^{n} {( {y}_{i} - \hat{y} )}^{2}} \qquad [ Formula 9 ]$$

$$MAE = \frac{1}{n} {\sum }_{i = 1}^{n} \vert {y}_{i} - \hat{y} \vert \qquad [ Formula 10 ]$$

$$NRMSE ( \% ) = \frac{RMSE}{max ( {y}_{i} ) ) - min ( {y}_{i} )} * 100 \qquad [ Formula 11 ]$$

$$mMAPE = \{ \begin{matrix}\begin{matrix}\frac{100}{n} {\sum }_{i = 1}^{n} \vert {y}_{i} - \hat{{y}_{i}} \vert , if & {\vert {y}_{i} \vert}_{max} < 1\end{matrix} \\ \frac{100}{n} {\sum }_{i = 1}^{n} \frac{\vert {y}_{i} - \hat{{y}_{i}} \vert}{{\vert {y}_{i} \vert}_{max}} , else\end{matrix} \qquad [ Formula 12 ]$$

The lifespan prediction unit 150 can predict the lifespan of a product using the first model constructed by the first model construction unit 110 and can predict the lifetime lifespan of test data and create lifetime lifespan prediction data by inputting the test data into the first model. In this case, the test data may be data including only product attribute data and product sale information without lifespan data, but is not necessarily limited thereto.

The total sales volume prediction unit 160 can predict a product lifetime total sales volume using the second model constructed by the second model construction unit 120. The total sales volume prediction unit 160 can predict a product lifetime total sales volume by inputting the lifetime lifespan prediction data and the test data into the second model.

The communication unit 170 can communicate with other network device through a network and can receive data for modeling data and information for studying a prediction model having high completeness. The network includes a Local Area Network (LAN), a Wide Area Network (WAN), a Value Added Network (VAN), a mobile radio communication network, a satellite network, and a combination thereof. The network is a data network in a compressive meaning and may include a wired internet, a wireless internet, and mobile wireless communication network. Further, the wireless communication, for example, may be Wi-Fi, Bluetooth, Bluetooth low energy, ZigBee, Wi-Fi Direct (WFD), ultra wideband (UWB), infrared Data Association (IrDA), Near Field Communication (NFC), etc., but is not limited thereto.

The control unit 180 controls processing by a process related to construction of the first model and the second model and controls the operation of each of the components.

In order to verify the effectiveness of the method and apparatus for predicting a product lifetime total sales volume through a hybrid model based on machine learning of the present disclosure, an example of applying the method and apparatus to an exemplary case of the domestic fashion-field retailing is described hereafter.

In this study, data of the domestic fashion-field retailing was used to predict the lifespan of products. A dataset includes a product attribute category and a product sale information category. Matters about the basic attributes of a product such as a product item, a product price, and a product design are included in product attribute data. Product sale information data is time-series data about the sale record of each product from Jan. 1, 2017 to Apr. 30, 2022 and includes selling date and time, a sales volume, a selling price, etc. Further, an average demand interval, a coefficient of variation, etc. were added to increase the prediction performance. The lifespan of a product is defined as the period from the date and time at which sale of the product was started and the date and time at which sale was ended, a product lifetime total sales volume was derived by summing up all of the sales volumes during the lifetime period, and the product lifespan and product lifetime total sales volume were added to training data.

In a total of 1,416 products included in the product attribute data, 24 data points in which the sales period is less than 4 weeks and 80 data points having a product lifetime total production volume outlier were removed from the data to create product sale information time-series features, thereby determining product attribute data of a total of 1,312 products as final data. In the data, 1050 items were randomly used as training data and 262 items were also randomly used as test data.

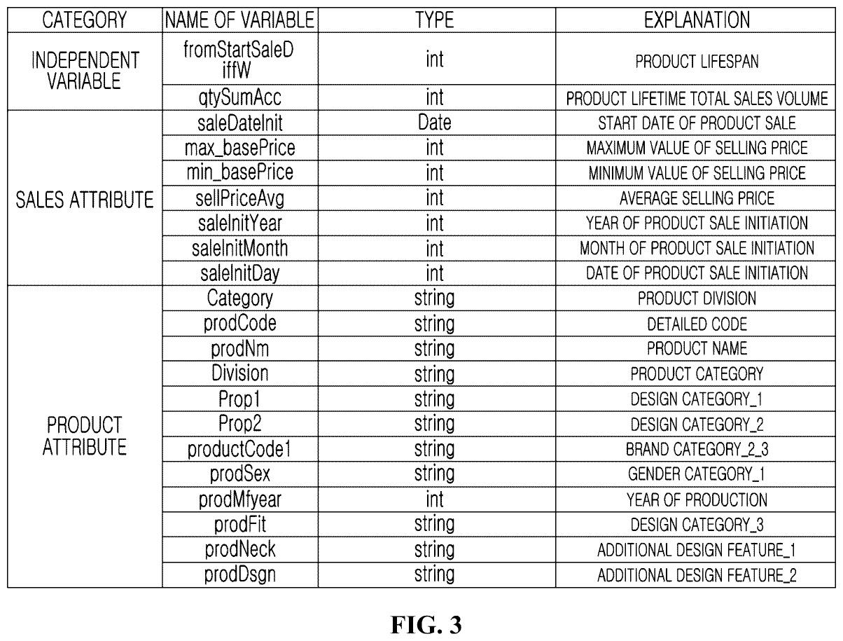

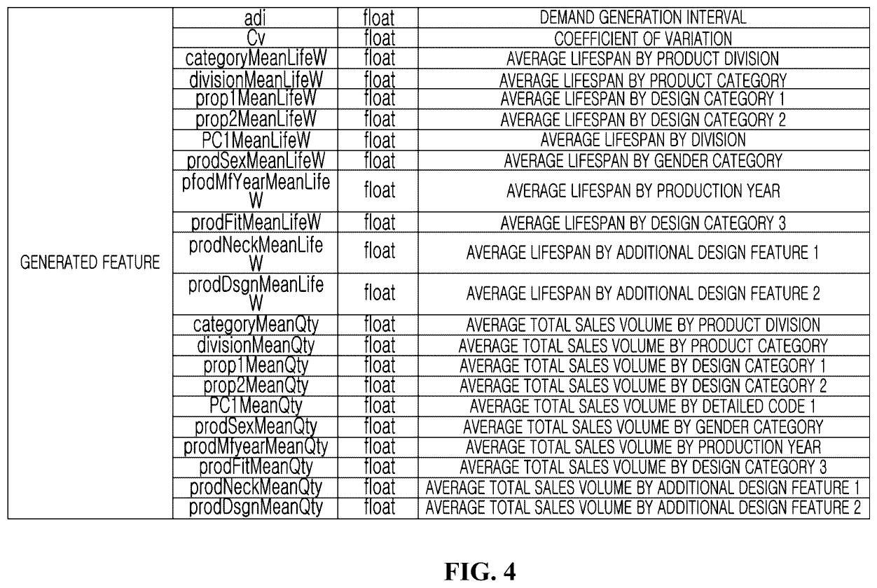

FIG. 3 and FIG. 4 are tables showing variable composition of training data according to an embodiment of the present disclosure. Referring to FIG. 3 and FIG. 4, variables additionally created on the basis of the attribute, the lifespan, and the sales volume of each item are included in the explanation variable that is used to predict a product lifespan and a product lifetime total production volume that are target variables to be predicted.

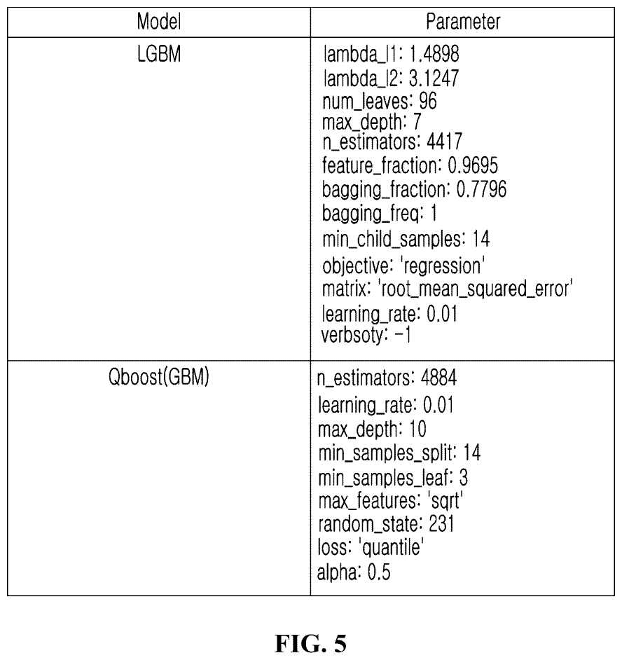

First, prediction of the lifespan of each product is performed through a first model, which uses an LGBM model, using the attribute of each product as an input variable. Further, prediction of a lifetime total sales volume is performed through a second model, which uses a QBoost model, by adding the lifespan data of a product to the attribute of each product. FIG. 5 is a table showing hyperparameters of each of the models according to an embodiment of the present disclosure. Referring to FIG. 5, it is possible to see the parameters of each model that was applied to this experiment.

In order to evaluate the performance of a hybrid model combining the product lifespan prediction model, which combines the LGBM model and the QBoost model, and the product lifetime total sales volume model, benchmarking models are set into five types as follows. The first three benchmarking models are single models and predict a product lifetime total sales volume using Random Forest, LGBM, and QBoost models, respectively. These models are models that predict a product lifetime total sales volume that is a target variable using only the other explanation variable without including the product lifespan in the dataset. Through comparison with these three benchmarking models, it is possible to check the effect of attempting data augmentation by predicting a product lifespan through LGBM.

The fourth and fifth benchmarking models are hybrid models such as LGBM+Random Forest and LGBM+LGBM. The lifespan of a product is predicted through LGBM, data augmentation is attempted by adding the lifespan to an explanation variable, and then a product lifetime total sales volume is predicted through LGBM. Through comparison to these models, it is possible to check the effect of predicting a product lifetime total sales volume of the QBoost model in the hybrid model combining the product lifespan prediction model and the product lifetime total sales volume model.

A first step is to predict the lifespan of a product using LGBM. In this study, the unit that shows the lifespan of a product was set as weeks. It was attempted to predict the lifespan of products by constructing prediction models through LGBM, Random Forest, QBoost, etc., respectively. An entire dataset was used to check the performance of the models using a K-folds cross validation method in order to evaluate prediction performance. k was set as 5, the point of each fold was obtained, and an average was obtained, whereby final performance was obtained.

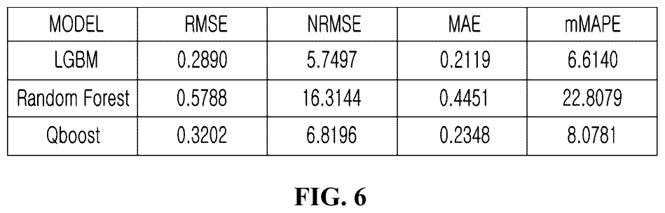

FIG. 6 is a table showing model accuracy in product lifespan prediction according to an embodiment of the present disclosure. Referring to FIG. 6, it is possible to see that LGBM is the most excellent in all of indexes in relation to the final performance of product lifespan prediction models.

A next step is a step of predicting the product lifetime total sales volumes using the QBoost model. The lifespan of a product is included as an explanation variable in training data for constructing a product lifetime total sales volume prediction model. QBoost can select various quantile models by adjusting a quantile value and the QBoost models used in this study are all models selected as medians (50th percentile).

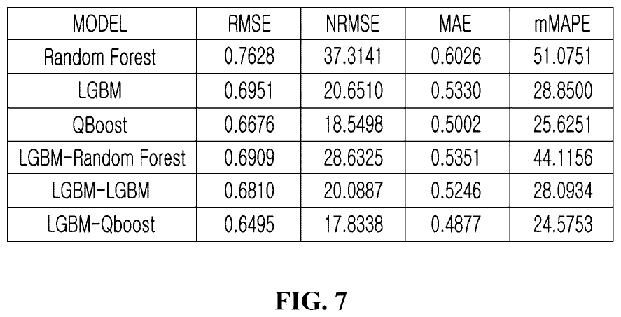

FIG. 7 is a table comparing accuracy of lifetime total sales volume prediction models on the basis of RMSE, NRMSE, MAE, mMAPE, etc. according to an embodiment of the present disclosure. Referring to FIG. 7, it was found that the proposed LGBM-QBoost model shows excellent prediction performance in all of indexes in comparison to other benchmarking models. Analyzing this in detail, excellent prediction performance was shown when a lifespan was predicted through LGBM and then a total sales volume was predicted through QBoost using a dataset updated by applying the lifespan in comparison to predicting a lifetime total sales volume of a product through a single QBoost model. This was the same in prediction of a product lifetime total sales volume not only by QBoost, but by single models of Random Forest, and LGBM. All of the models show more accurate performance when attempting to predict a total sales volume after the process of augmenting data through LGBM lifespan prediction. This means that a process of predicting a lifespan is an important factor in prediction of a lifetime total sales volume of a product.

Considering only the situation in which the lifetime total sales volume of a product is predicted through a signal model, LGBM shows higher performance than Random Forest or QBoost. However, when a hybrid model was included, LGBM-QBoost showed higher performance. This means that it is important to derive an appropriate combination of models optimized for prediction of a lifespan and a total sales volume rather than solving a prediction problem simply using only a single model. This experiment shows that the combination of LGBM predicting a lifespan and QBoost predicting a product lifetime total sales volume is the most excellent model.

Consequently, as the result of analyzing performance of prediction models on the basis of four evaluation indexes, the combination model LGBM+QBoost proposed in the present disclosure showed excellent performance in comparison to single models such as Random Forest, LGBM, and QBoost and hybrid models such as LGBM+LGBM and LGBM+Random Forest configured on the basis of the single models.

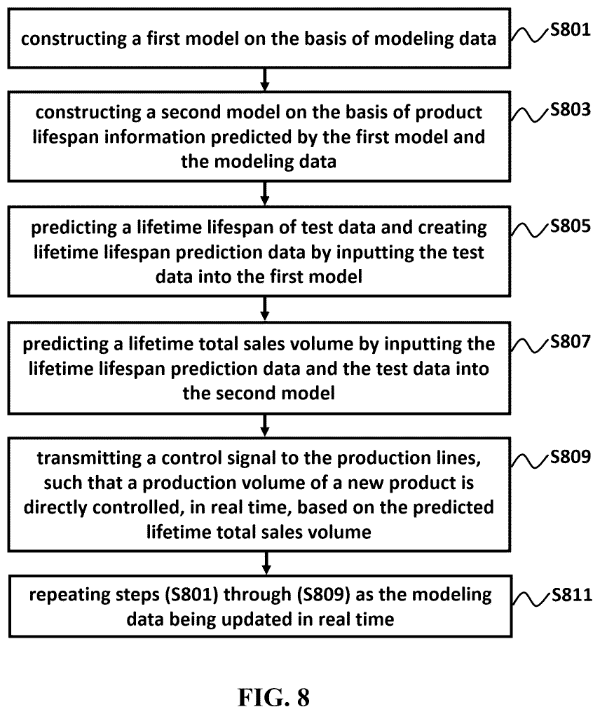

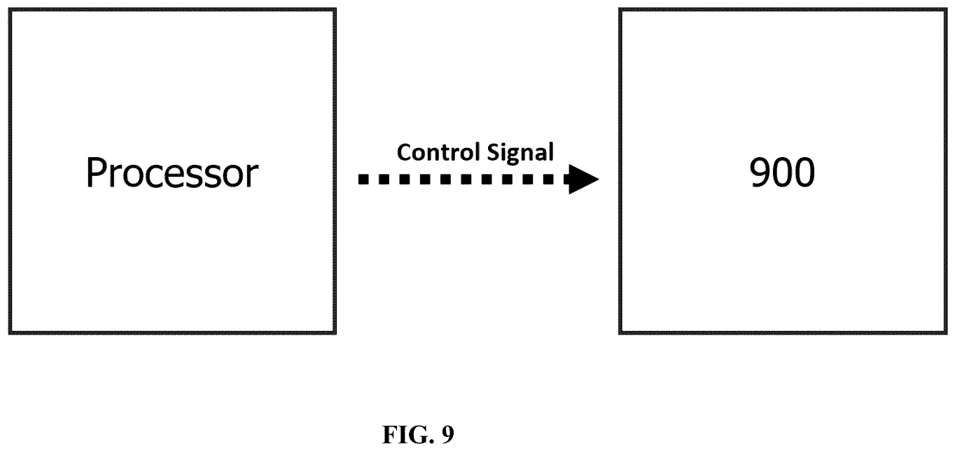

Turning now to FIGS. 8 and 9, FIG. 8 is a flowchart illustrating a for controlling production lines based on prediction of machine learning models according to one embodiment of the present disclosure, and FIG. 9 is a block diagram of an apparatus for controlling production lines based on prediction of machine learning models according to one embodiment of the present disclosure. According to an exemplary embodiment, the predicted product lifetime total sales volume may control production lines 900. In an exemplary embodiment, the method of controlling production lines based on prediction of machine learning models may include: (S801) constructing a first model configured to predict a product lifespan on the basis of modeling data in a machine learning model; (S803) constructing a second model configured to predict a product total sales volume on the basis of product lifespan information predicted by the first model and the modeling data in the machine learning model; (S805) predicting a lifetime lifespan of test data and creating lifetime lifespan prediction data by inputting the test data into the first model; (S807) predicting a lifetime total sales volume by inputting the lifetime lifespan prediction data and the test data into the second model; (S809) transmitting a control signal to the production lines, such that a production volume of a new product is directly controlled, in real time, based on the predicted lifetime total sales volume; and (S811) repeating steps (S801) through (S809) as the modeling data being updated in real time.

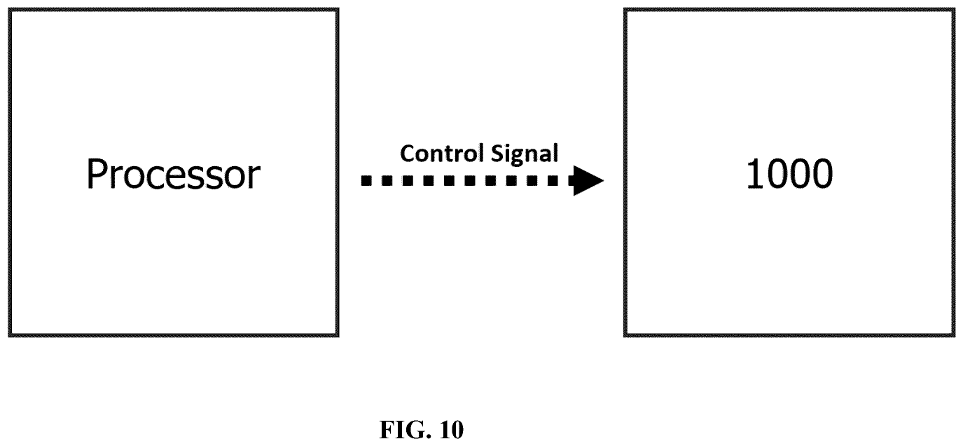

Turning now to FIG. 10, FIG. 10 is a block diagram of an apparatus for controlling an inventory management scheduler based on prediction of machine learning models according to one embodiment of the present disclosure. According to an exemplary embodiment, in the step (S809), the inventory management scheduler 1000 may further be controlled based on the predicted product lifetime total sales volume. In an exemplary embodiment, the inventory management scheduler 1000 may refer to an apparatus or a system to automate and optimize inventory processes. The inventory management scheduler 1000 may, based on the predicted product lifetime total sales volume, track stock levels, and trigger reordering or alerts to ensure the right amount of product is available at the right time, preventing stockouts and managing costs.

The method, the apparatus and the system according to embodiments as described hereinabove may be, at least in part, implemented as a computer program and recorded in a computer-readable recording medium. The computer-readable recording medium that records a program for implementing the operation by the method according to embodiments includes any type of recording device in which computer-readable data is stored. Examples of the computer-readable recording medium include ROM, RAM, CD-ROM, magnetic tape, floppy disk, optical data storage devices. Additionally, the computer-readable recording medium is distributed over computer systems connected via a network, and may store and execute the computer-readable code in a distributed manner. Additionally, a functional program, code and a code segment for realizing this embodiment will be easily understood by persons having ordinary skill in the technical field to which this embodiment belongs.

Thus, an apparatus of an exemplary embodiment may include a processor and a memory including computer program code, where the memory and the computer program code are configured, with the processor, to cause the device to perform the functions of the steps or the method of above discussed exemplary embodiments. Also, the term “processor” is synonymous with terms like controller and computer and “should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

Although the present disclosure has been described with reference to the exemplary embodiments illustrated in the drawings, those are only examples and may be changed and modified into other equivalent exemplary embodiments from the present disclosure by those skilled in the art. Therefore, the technical protective range of the present disclosure should be determined by the scope described in claims.

What is claimed is:

1. A computer-implemented method for controlling production lines based on prediction of a product lifetime total sales volume through a hybrid machine learning model, in the method, a memory stores one or more programs executed by one or more processors to perform the steps of:
(a) constructing a first model configured to predict a product lifespan on the basis of modeling data in a machine learning model;
(b) constructing a second model configured to predict a product total sales volume on the basis of product lifespan information predicted by the first model and the modeling data in the machine learning model;
(c) predicting a lifetime lifespan of test data and creating lifetime lifespan prediction data by inputting the test data into the first model;
(d) predicting a lifetime total sales volume by inputting the lifetime lifespan prediction data and the test data into the second model;
(e) transmitting a control signal to the production lines, such that a production volume of a new product is directly controlled, in real time, based on the predicted lifetime total sales volume; and
(f) repeating steps (a) through (e) as the modeling data being updated in real time.

2. The method of claim 1, wherein the modeling data is at least one of actual lifespan data, product attribute data, and product sale information data.

3. The method of claim 2, wherein the product sale information data is at least one of time-series data, selling date and time, a sales volume, and a selling price about a sales record of each product, and
the product attribute data is at least one of a product item, a product price, and product design.

4. An apparatus for controlling production lines based on prediction of a product lifetime total sales volume through a hybrid machine learning model, the apparatus comprising:
one or more processors; and
a memory which stores one or more programs executed by the one or more processors to perform:
(a) constructing a first model configured to predict a product lifespan on the basis of modeling data in a machine learning model;
(b) constructing a second model configured to predict a product total sales volume on the basis of product lifespan information predicted by the first model and the modeling data in the machine learning model;
(c) predicting a lifetime lifespan of test data and creating lifetime lifespan prediction data by inputting the test data into the first model;
(d) predicting a lifetime total sales volume by inputting the lifetime lifespan prediction data and the test data into the second model;
(e) transmitting a control signal to the production lines, such that a production volume of a new product is directly controlled, in real time, based on the predicted lifetime total sales volume; and
(f) repeating steps (a) through (e) as the modeling data being updated in real time.

5. The apparatus of claim 4, wherein the modeling data is at least one of actual lifespan data, product attribute data, and product sale information data,
the product sale information data is at least one of time-series data, selling date and time, a sales volume, and a selling price about a sales record of each product, and
the product attribute data is at least one of a product item, a product price, and product design.

6. A computer-implemented method for controlling an inventory management scheduler based on prediction of a product lifetime total sales volume through a hybrid machine learning model, in the method, a memory stores one or more programs executed by one or more processors to perform the steps of:
(a) constructing a first model configured to predict a product lifespan on the basis of modeling data in a machine learning model;
(b) constructing a second model configured to predict a product total sales volume on the basis of product lifespan information predicted by the first model and the modeling data in the machine learning model;
(c) predicting a lifetime lifespan of test data and creating lifetime lifespan prediction data by inputting the test data into the first model;
(d) predicting a lifetime total sales volume by inputting the lifetime lifespan prediction data and the test data into the second model;
(e) transmitting a control signal to the inventory management scheduler, in real time, based on the predicted lifetime total sales volume; and
(f) repeating steps (a) through (e) as the modeling data being updated in real time.
